(19) United States
(12) Patent Application Publication
(10) Pub. No.: US 2026/0044055 A1
(43) Pub. Date: Feb. 12, 2026

(54) LENS UNIT AND CAMERA UNIT INCLUDING THE SAME

(71) Applicant: NIDEC INSTRUMENTS CORPORATION, Nagano (JP)

(72) Inventor: Toshio SHIROTORI, Nagano (JP)

(21) Appl. No.: 19/099,458

(22) PCT Filed: Jul. 21, 2023
(86) PCT No.: PCT/JP2023/026742

§ 371 Date: Jan. 28, 2025

(30) Foreign Application Priority Data
Jul. 29, 2022 (JP) 2022-121260

(51) Int. Cl. G03B 17/08; G02B 1/04; G02B 7/02; G03B 17/12

(52) U.S. Cl. CPC G03B 17/08; G02B 1/041; G02B 7/021; G02B 7/022; G03B 17/12

(57) ABSTRACT

A lens unit in a camera unit includes a first lens which is a lens, a lens holder in a tube shape which holds the first lens, and an O-ring which is a seal member. The first lens is fixed to the lens holder using a screw structure. The O-ring is sandwiched between the first lens and the lens holder in the optical axis direction,

### RELATED APPLICATIONS

The present application is National stage of application No. PCT/JP2023/026742, filed on Jul. 21, 2023, and claims priority based on Japanese Patent Application No. 2022-121260, filed Jul. 29, 2022.

### TECHNICAL FIELD

The present invention relates to a lens unit and a camera unit including the same and, especially, relates to a fixing technique of a lens to a support body such as a lens holder.

### BACKGROUND ART

The following Patent Literature 1 discloses a lens unit in which a lens is fixed to a lens holder by heating and pressurizing a claw or a projection made of resin and plastically deforming it.

### CITATION LIST

### Patent Literature

[PTL 1] Japanese Patent Laid-Open No. 2015-210334

### SUMMARY OF THE INVENTION

### Problems to be Solved by the Invention

Like the lens unit described in the Patent Literature 1, in a case that a claw or the like made of resin is deformed by heat to make a lens fix to a lens holder, in order to detach the lens after the lens is fixed, the claw or the like is required to be damaged. In other words, the lens fixed to the lens holder cannot be exchanged after the lens is fixed.

Further, in a case that the lens is a lens which presses an O-ring in an optical axis direction, the lens may float by a repulsive force of the O-ring while the claw deformed by heat is cooled to become hard. The floating may decrease a crushing ratio of the O-ring to degrade waterproof performance of the lens unit.

In view of the problem described above, an objective of the present invention is to provide a lens unit and a camera unit whose maintainability and serviceability are improved and their waterproof performances are stabilized.

### Means to Solve the Problems

To solve the above-mentioned problem, the present invention provides a lens unit including a first lens which is a lens, a lens holder in a tube shape which holds the first lens, and an O-ring which is a seal member. The first lens is fixed to the lens holder by a fixing means using a screw structure, and the O-ring is sandwiched between the first lens and the lens holder in an optical axis direction.

When the first lens and the lens holder are fixed to each other by a fixing means using a screw structure, even after fixation, the first lens can be detached without damaging the lens holder. Further, floating of the first lens due to a repulsive force of the O-ring is also prevented.

In this case, it is preferable that the first lens is a plastic lens, and the fixing means is structured of a male screw which is formed on an outer peripheral face of the first lens and a female screw which is formed on an inner peripheral face of the lens holder. When a plastic lens is used, the first lens itself is capable of forming a male screw with a high degree of molding accuracy, and the fixing means using a screw structure can be realized in a simple structure.

Further in this case, it is preferable that the first lens and the lens holder include, separately from the fixing means, optical axis direction positioning parts which are contacted with each other in the optical axis direction to determine a position in the optical axis direction of the first lens with respect to the lens holder and, when a direction perpendicular to the optical axis direction is referred to as a radial direction, the first lens is provided with a flange part which is protruded to an outer side in the radial direction with respect to a position of the male screw on an object side with respect to the male screw, and the optical axis direction positioning parts are structured of an image side face of the flange part and a face of the lens holder facing the image side face. In a case that a lens is to be fixed by a fixing means using a screw structure, in order to threadedly engage a screw smoothly, appropriate play (backlash) is required. The play may cause rattling of the lens in the optical axis direction and an individual difference and/or disturbance of a lens position. When the optical axis direction positioning parts are provided separately from the screw structure, the adverse effects are suppressed and optical quality of the lens unit can be stabilized.

Further in this case, it is preferable that the first lens and the lens holder include, separately from the fixing means, radial direction positioning parts which are contacted with each other in the radial direction to determine a position in the radial direction of the first lens with respect to the lens holder, the first lens is provided with a fitting part in a tubular shape or a columnar shape on an image side with respect to the male screw, and the radial direction positioning parts are structured of an outer peripheral face of the fitting part and a face of the lens holder facing the outer peripheral face. In a case that a lens is to be fixed by a fixing means using a screw structure, in order to threadedly engage a screw smoothly, appropriate play (a difference of effective diameters) is required. The play may cause rattling of a lens in the radial direction and an individual difference and/or disturbance of a lens position. When the radial direction positioning parts are provided separately from the screw structure, the adverse effects are suppressed and optical quality of the lens unit can be stabilized. In accordance with an embodiment of the present invention, it may be structured that the first lens is provided with a fitting part in a tubular shape or a columnar shape on an object side with respect to the male screw, and the radial direction positioning parts are structured of an outer peripheral face of the fitting part and a face of the lens holder facing the outer peripheral face.

Further, it is preferable that the outer peripheral face of the fitting part is disposed on an outer side in the radial direction with respect to a position of the O-ring. The male screw of the first lens is threadedly engaged with an inner peripheral face of the lens holder and thus, the male screw is commonly disposed on an outer side (in the radial direction) with respect to the O-ring. The fitting part has an objective for eliminating a harmful effect due to play of a screw structure and thus, it is preferable that the fitting part is continuously provided with the male screw, in other words, disposed an outer side with respect to a position of the O-ring. Further, when structured as described above, the radial direction positioning part can be provided by working a part of a forming surface of the male screw and thus, complication of a structure due to providing the radial direction positioning part is suppressed.

Further, the lens unit in accordance with the present invention may be structured so that the first lens is a plastic lens having a tube-shaped part, and the fixing means is structured of a male screw which is formed on an outer peripheral face of the lens holder and a female screw which is formed on an inner peripheral face of the tube-shaped part. An effect obtained by using a plastic lens and providing the first lens itself with a screw structure is described above.

In this case, it is preferable that the first lens and the lens holder include optical axis direction positioning parts separately from the fixing means, an image side face of the first lens is formed with a ring-shaped groove part, the female screw is formed on a wall surface on an outer side in the radial direction of wall surfaces of the groove part, and the optical axis direction positioning parts are structured of a bottom face of the groove part and a face of the lens holder facing the bottom face. An effect obtained by providing the optical axis direction positioning parts separately from a screw structure is described above.

Further, in this case, it is preferable that the first lens and the lens holder include radial direction positioning parts separately from the fixing means, and the radial direction positioning parts are structured of a wall surface on an inner side in the radial direction of the wall surfaces of the groove part and a face of the lens holder facing the wall surface. An effect obtained by providing the radial direction positioning parts separately from a screw structure is described above.

Further, in the lens unit in accordance with the present invention, it is preferable that an outer face of the first lens is provided with a protrusion or a recess such as a recessed part, protruded part, notch, knurling, serration, spline or the like capable of engaging with a jig, a tool or a finger in a circumferential direction in a portion which does not affect optical performance. According to this structure, the first lens can be easily exchanged. Especially, in such a case that a lens unit is very small or very large and, when it is difficult to turn the first lens without using some tool, such protrusions and recesses are required for exchanging the first lens.

Further, in the lens unit in accordance with the present invention, it may be structured that the first lens is provided with a lens part which determines its optical performance and a non-lens part which is enlarged from the lens part to an outer side in the radial direction, the non-lens part is formed with a plurality of holes, and the first lens is fixed to the lens holder by passing a screw through the hole of the non-lens part. An effect obtained by fixing the lens holder and the first lens by a fixing means using a screw structure is described above. Further, the hole of the non-lens part may be a hole having no screw groove (so-called loose hole or drill hole) and thus, the above-mentioned structure can be applied to a glass lens which is difficult to form a screw.

In this case, it is preferable that the first lens and the lens holder include optical axis direction positioning parts separately from the fixing means, and the optical axis direction positioning parts are structured of an image side face of the non-lens part and a face of the lens holder facing the image side face. An effect obtained by providing the optical axis direction positioning parts separately from a screw structure is described above.

Further, in this case, it is preferable that the first lens and the lens holder include radial direction positioning parts separately from the fixing means, the first lens is provided with a fitting part in a tubular shape or a columnar shape on an inner side in the radial direction with respect to the O-ring, and the radial direction positioning parts are structured of an outer peripheral face of the fitting part and a face of the lens holder facing the outer peripheral face. An effect obtained by providing the radial direction positioning parts separately from a screw structure is described above.

As described above, in the lens unit in accordance with the present invention, it is preferable that the first lens and the lens holder include, separately from the fixing means, optical axis direction positioning parts which are contacted with each other in the optical axis direction to determine a position in the optical axis direction of the first lens with respect to the lens holder and, further, it is preferable that the first lens and the lens holder include, separately from the fixing means, radial direction positioning parts which are contacted with each other in the radial direction to determine a position in the radial direction of the first lens with respect to the lens holder.

Further, in the lens unit in accordance with the present invention, the first lens and the lens holder are joined to each other with an adhesive. In addition to a fixing means using a screw structure, when the first lens and the lens holder are joined to each other with an adhesive, looseness of a screw after fixation can be prevented.

In this case, it is preferable that the adhesive is a dismantlable adhesive which is capable of releasing adhesion by performing specific processing on a joined part after bonding. As a result, both of prevention of looseness of a screw and easiness in replacement of the first lens can be attained.

Further, in the lens unit in accordance with the present invention, it is preferable that the lens unit includes a plurality of lenses which are arranged along the optical axis direction, the first lens is a lens disposed on the most object side among the plurality of the lenses, and a lens which is disposed on an image side with respect to the first lens is caulked and fixed to the lens holder. When the most suitable fixing method is selected depending on a property of an individual lens and its used environment, optical quality, maintainability, serviceability, assemblability, cost efficiency and the like of a lens unit can be improved in a well-balanced manner.

Further, to solve the above-mentioned problem, the present invention provides a camera unit including a plurality of lenses arranged along an optical axis direction, a lens holder in a tube shape, an O-ring which is a seal member, a camera module, and a camera case accommodating the camera module. When a lens on the most object side among the plurality of the lenses is referred to as a first lens, the lens holder holds a lens disposed on an image side with respect to the first lens, the first lens is provided with a lens part which determines its optical performance and a non-lens part which is enlarged from the lens part to an outer side in the radial direction, the non-lens part is formed with a plurality of holes, the first lens is fixed to a face on an object side of the camera case by passing a screw through the hole of the non-lens part, and the O-ring is sandwiched between the first lens and the camera case or the lens holder in the optical axis direction.

An effect attained by fixing the first lens with a fixing means using a screw structure is similar to that described above. Further, an effect attained by fixing the non-lens part of the first lens with a screw is also similar to that described above. In this case, in order to fix the non-lens part of the first lens with a screw, a certain area is required in the non-lens part. In other words, an adverse effect that a size of the unit is increased may occur. According to the present invention, the first lens is directly fixed to a camera case instead of a lens holder and, as a result, while attaining an effect by a fixing means using a screw structure, the adverse effect can be reduced.

### Effects of the Invention

As described above, according to the present invention, maintainability and serviceability of the lens unit and the camera unit are improved and their waterproof performances are stabilized.

### BRIEF DESCRIPTION OF THE DRAWINGS

FIG. 1 is a cross-sectional side view showing an internal structure of a lens unit in accordance with a first embodiment of the present invention.

FIG. 2 is an enlarged view showing a portion surrounded by the one-dot chain line in FIG. 1.

FIG. 3 is a perspective view showing a structure of cut-out parts of a first lens.

FIGS. 4A and 4B are partial enlarged views showing modified embodiments of a lens unit in accordance with the first embodiment of the present invention.

FIG. 5 is a cross-sectional side view showing an internal structure of a lens unit in accordance with a second embodiment of the present invention.

FIG. 6 is an enlarged view showing a portion surrounded by the one-dot chain line in FIG. 5.

FIG. 7 is a cross-sectional side view showing an internal structure of a camera unit in accordance with a third embodiment of the present invention.

FIG. 8 is an enlarged view showing a portion surrounded by the one-dot chain line in FIG. 7.

FIG. 9 is a plan view showing a camera unit.

FIG. 10A is a cross-sectional side view showing an internal structure of a lens unit in accordance with a fourth embodiment of the present invention, and FIG. 10B is its side view. FIG. 11 is a side view showing a modified embodiment of a lens unit in accordance with the fourth embodiment of the present invention.

### DESCRIPTION OF EMBODIMENTS

Embodiments of a lens unit and a camera unit in accordance with the present invention will be described below with reference to the accompanying drawings.

Features of a lens unit and a camera unit described below are methods of fixing a lens, especially, a lens which is disposed on the most object side. Specifically, for fixing a lens, a fixing means using a screw structure is employed, or a fixing means using an arm and a hook which are capable of elastically deforming is employed and thereby, the lens after having been fixed can be detached and, in addition, positional deviation of the lens due to a repulsive force of an O-ring is prevented. Next, the features and the incidental features will be described below based on various embodiments of the present invention.

### first Embodiment

### (Entire Structure)

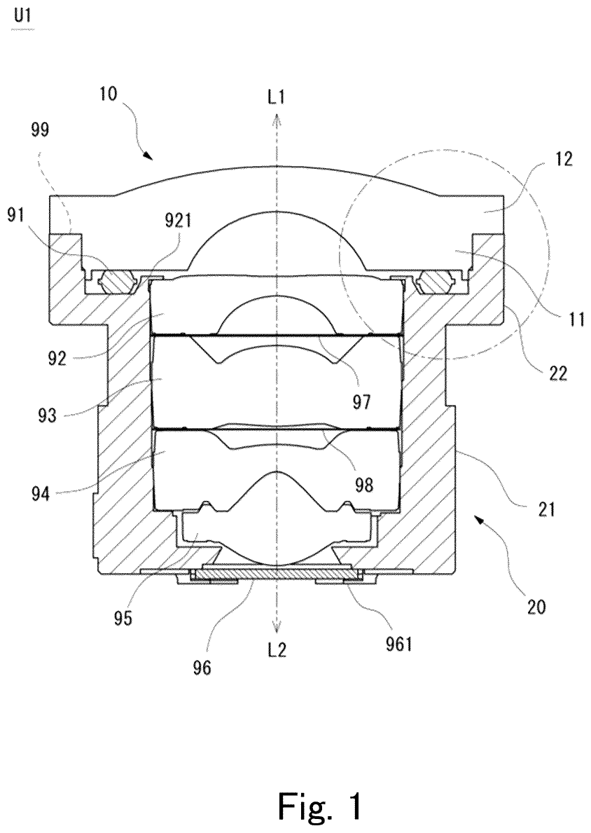

A lens unit “U1” in this embodiment is a small general-purpose lens unit which is employed in various imaging devices. FIG. 1 is a cross-sectional side view showing an internal structure of a lens unit “U1” in accordance with a first embodiment of the present invention. Next, an entire structure of the lens unit “U1” will be described below with reference to FIG. 1.

The two-dot chain line “L1-L2” shown in FIG. 1 shows an optical axis of the lens unit “U1”, and the “L1” side is an object side (subject side) and the “L2” side is an image side. For convenience of explanation with reference to the drawings, the “L1” side may be referred to as an “upper” side, and the “L2” side may be referred to as a “lower” side. Further, a direction perpendicular to an optical axis direction is referred to as a “radial direction” and may be also referred to as a “horizontal direction” for convenience. Further, in the following descriptions, a “circumferential direction”means a direction around the optical axis.

The lens unit “U1” includes a first lens 10 through a fifth lens 95 which are five lenses arranged along the optical axis “L1-L2” and a lens holder 20 which holds these lenses. A light shielding plate 97 is disposed between a second lens 92 and a third lens 93, and a diaphragm 98 is disposed between the third lens 93 and a fourth lens 94. Further, an optical filter 96 is disposed on an end face on the most image side of the lens holder 20, and the optical filter 96 is caulked and fixed to the end face of the lens holder 20 by claw parts 961 made of resin. Further, the second lens 92 is caulked and fixed by a rib 921 in a circular ring shape made of resin which is provided in the lens holder 20.

The lenses in this embodiment are all plastic lenses, and the fifth lens 95 and the fourth lens 94 located on the most image side structure a cemented lens. In this embodiment, a number and a type of lenses which are held by the lens holder 20 are not limited to the structure in this embodiment and may be appropriately modified depending on a use of the lens unit and a subject.

The lens holder 20 is a lens barrel or a lens frame which holds these lenses and is provided with a cylindrical small diameter part 21 and a large diameter part 22 having an inner diameter larger than the small diameter part 21. The large diameter part 22 and the small diameter part 21 are connected with each other by a flat face part in a circular ring shape which is horizontally widened from an upper end of the small diameter part 21. The first lens 10 is held by the large diameter part 22, and the second lens 92 through the fifth lens 95, the light shielding plate 97 and the diaphragm 98 are held by the small diameter part 21. The structure of the lens holder 20 is not limited to that in this embodiment and, when a screw structure or a hook structure described below is provided, a lens holder of any structure may be used.

An O-ring 91 is placed on the flat face part which connects the small diameter part 21 with the large diameter part 22 of the lens holder 20. The O-ring 91 is a seal member which prevents water from entering into the lens unit “U1” from an object side. The O-ring 91 is sandwiched between the flat face part on which the O-ring 91 is placed and a lower face of the first lens 10 and is compressed in the optical axis direction.

### (Fixing Structure of First Lens)

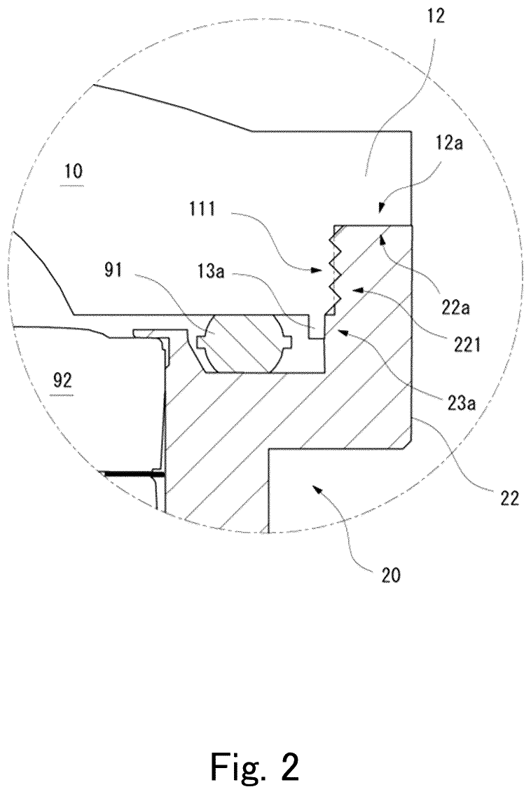

FIG. 2 is an enlarged view showing a portion surrounded by the one-dot chain line in FIG. 1 and is a view showing details of a fixing structure of the first lens 10. Next, a fixing structure of the first lens 10 in this embodiment will be described below with reference to FIG. 2.

The first lens 10 is a plastic lens having negative power. The first lens 10 is formed with a male screw 111 on an outer peripheral face of its body part 11 (see FIG. 1). A flange part 12 in a circular ring shape which is projected to an outer side in a radial direction with respect to the male screw 111 is provided on an upper side of the male screw 111. A lens side fitting part 13a which is a cylindrical tubular-shaped fitting part protruded to a lower side is provided on a lower side of the male screw 111.

The large diameter part 22 of the lens holder 20 is a tube part in a cylindrical tubular shape. An inner peripheral face of the large diameter part 22 is formed with a female screw 221 corresponding to the male screw 111 of the first lens 10. A holder side fitting part 23a which is an inner peripheral face projected to an inner side in the radial direction with respect to a top part of a thread of the female screw 221 is provided on a lower side of the female screw 221.

As shown in FIG. 2, the first lens 10 is fixed to the lens holder 20 by a fixing means using a screw structure. Specifically, the first lens 10 is fixed to the lens holder 20 by threadedly engaging the male screw 111 with the female screw 221 of the lens holder 20. As described above, the first lens 10 in this embodiment is a plastic lens. Since a plastic lens is used, the first lens 10 itself is capable of forming the male screw 111 with a high degree of molding accuracy and a fixing means using a screw structure is realized in a simple structure. Further, since the lens holder 20 and the first lens 10 are fixed to each other by a screw structure, even after the first lens 10 is fixed, the first lens 10 can be detached without damaging the lens holder 20. In addition, floating of the first lens 10 due to a repulsive force of the O-ring 91 is also prevented. Although a plastic lens is inexpensive in comparison with a glass lens, hardness of a plastic lens is inferior to a glass lens and thus, a plastic lens is easily scratched. According to the lens unit “U1”, when performance of the first lens 10 is degraded due to scratches, the first lens 10 can be easily exchanged.

The first lens 10 and the lens holder 20 in this embodiment are, separately from the above-mentioned screw structure, provided with optical axis direction positioning parts which are contacted with each other in the optical axis direction to determine a position of the first lens 10 in the optical axis direction with respect to the lens holder 20. The optical axis direction positioning parts in this embodiment are structured of a lower face 12a of the flange part 12 of the first lens 10 and an upper face 22a of the large diameter part 22a facing the lower face 12a.

Further, the first lens 10 and the lens holder 20 in this embodiment are, separately from the above-mentioned screw structure, provided with radial direction positioning parts which are contacted with each other in a radial direction to determine a position of the first lens 10 in the radial direction with respect to the lens holder 20. The radial direction positioning parts in this embodiment are structured of an outer peripheral face of the lens side fitting part 13a of the first lens 10 and the holder side fitting part 23a of the large diameter part 22 facing the outer peripheral face of the lens side fitting part 13a.

In a case that a lens is to be fixed by a fixing means using a screw structure, in order to threadedly engage a screw smoothly, appropriate play (backlash and a difference of effective diameters) is required. The play may cause rattling of a lens in an optical axis direction and/or a radial direction and an individual difference and/or disturbance of a lens position. The lens unit “U1” in this embodiment includes the optical axis direction positioning parts and/or the radial direction positioning parts separately from the screw structure and thus, the above-mentioned adverse effects are suppressed and optical quality of the lens unit “U1”is stabilized.

Further, as shown in FIG. 1, in the lens unit “U1”, the first lens 10 and the lens holder 20 are, in addition, joined to each other by an adhesive 99. In addition to a fixing means using the screw structure, the first lens 10 and the lens holder 20 are adhesively bonded to each other by the adhesive 99 to prevent looseness of the screw after fixation.

In this embodiment, the adhesive 99 is a thermoplastic adhesive and thus, after bonding, the adhesion can be released by heating the joined part again. As a result, both of prevention of looseness of the screw and easiness in replacement of the first lens 10 are attained. In this embodiment, a usable adhesive is not limited to a thermoplastic adhesive, and an adhesive (so-called dismantlable adhesive) which is capable of releasing adhesion by performing specific processing on a joined part after bonding may be employed. Alternatively, an adhesive may be employed which is provided with an adhesive strength at a level capable of preventing looseness of the screw and is capable of peeling off without damaging the first lens 10 and the lens holder 20 if the adhesive is going to be peeled off. The joining of the adhesive 99 may be employed in the following second through fourth embodiments.

### (Exchange Aid Structure of First Lens)

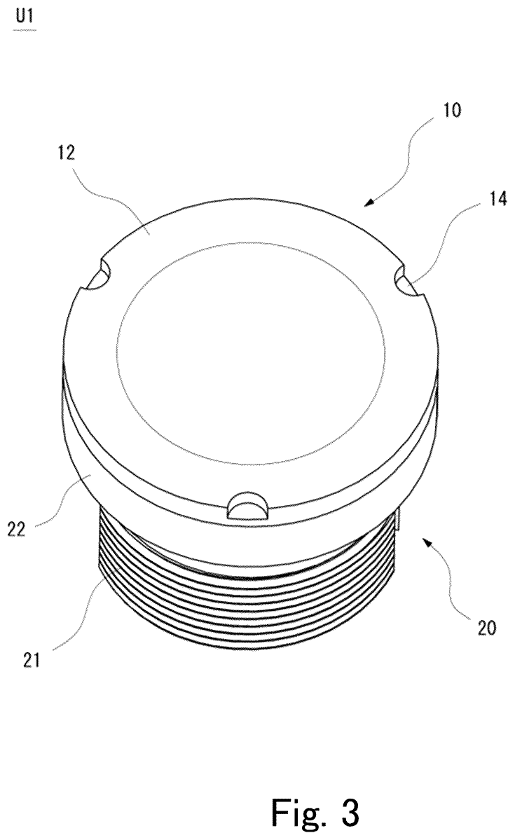

FIG. 3 is a perspective view showing a structure of cut-out parts 14 of the first lens 10. As shown in FIG. 3, the first lens 10 is provided with three cut-out parts 14 which are provided at an outer edge of the flange part 12 at equal intervals in a circumferential direction.

As described above, the lens unit “U1” in this embodiment is a small lens unit, and its diameter dimension is about 15-16 mm. In a small lens unit like the lens unit “U1” and, to the contrary, in a very large lens unit, it is sometimes difficult to exchange the first lens 10 by fingers. In the lens unit “U1”, the first lens 10 is provided with the cut-out parts 14 and thus, the first lens 10 can be easily and safely exchanged by using a dedicated tool. In this embodiment, a shape and structure of the cut-out part 14 are not limited to a type of the lens unit “U1”. The cut-out part 14 may be a protrusion and/or a recess, for example, a recessed part, protruded part, knurling, serration, spline and the like, which are provided in a portion not affecting optical performance of a lens and are capable of engaging in a circumferential direction with a jig, a tool or fingers. In a case that the first lens 10 is difficult to turn without using some tool, the first lens 10 is required to have such a protrusion and/or a recess for exchange.

### (Modified Embodiment)

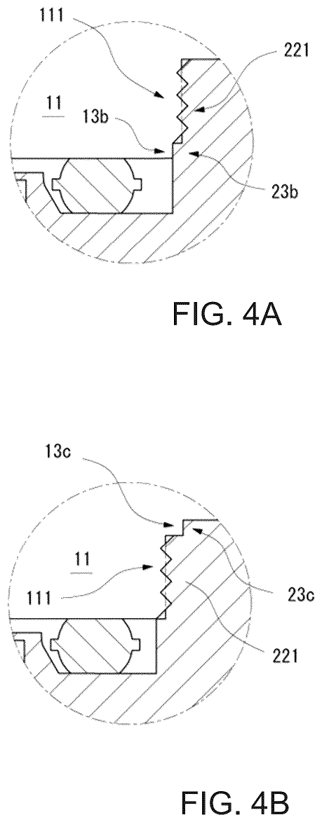

FIGS. 4A and 4B are partial enlarged views showing modified embodiments of the lens unit “U1”. The embodiments described below are principally modified embodiments of the lens side fitting part 13a and the holder side fitting part 23a which structure the radial direction positioning parts of the lens unit “U1”.

As shown in FIG. 2, the lens side fitting part 13a of the above-mentioned embodiment is a portion in a cylindrical tubular shape which is protruded to a further lower side from a lower end of the body part 11 (see FIG. 1) of the first lens 10. In the modified embodiment in FIG. 4A, an outer diameter of a lower end part of the body part 11 is set smaller than a diameter of a bottom part of a screw groove of the male screw 111 and thereby, the body part 11 itself is provided with a lens side fitting part 13b. On the other hand, a structure of the lens holder 20 is substantially the same as the holder side fitting part 23a in the above-mentioned embodiment, and a holder side fitting part 23b which is protruded to an inner side in a radial direction with respect to a top part of a thread of the female screw 221 is provided on a lower side of the female screw 221.

In a modified embodiment shown in FIG. 4B, an outer diameter of an upper end part of the body part 11 is set larger than a diameter of a top part of a thread of the male screw 111 and thereby, the body part 11 itself is also provided with a lens side fitting part 13c. The lens holder 20 is provided with a holder side fitting part 23c which is an inner peripheral face expanded to an outer side in a radial direction with respect to a bottom part of a screw groove of the female screw 221 on an upper side of the female screw 221.

In each of the embodiment described above and the modified embodiments, the outer peripheral faces of the lens side fitting parts 13a, 13b and 13c are disposed on an outer side in the radial direction with respect to a position of the O-ring 91. The male screw 111 of the first lens 10 is threadedly engaged with an inner peripheral face of the lens holder 20 and thus, the male screw 111 is commonly disposed on an outer side (in the radial direction) with respect to the O-ring 91. The lens side fitting parts 13a, 13b and 13c are used to eliminate an adverse effect due to play in a screw structure and thus, it is preferable that the lens side fitting parts 13a, 13b and 13c are continuously provided with the male screw 111, in other words, disposed on an outer side with respect to a position of the O-ring 91. Further, according to this structure, the radial direction positioning part can be provided by processing a part of a formation face or near the formation face (in other words, on an outer peripheral face of the body part 11) of the male screw 111 and complication of a structure due to providing the radial direction positioning part is reduced.

### Second Embodiment

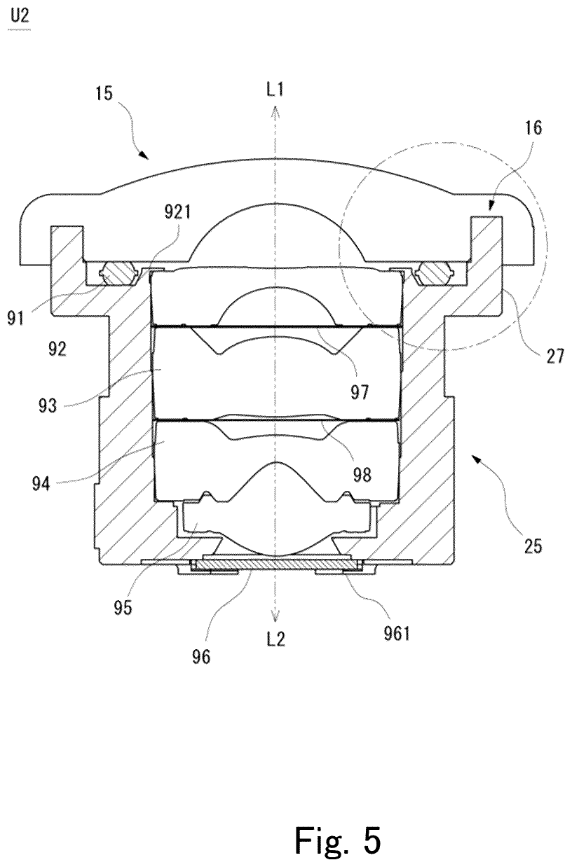

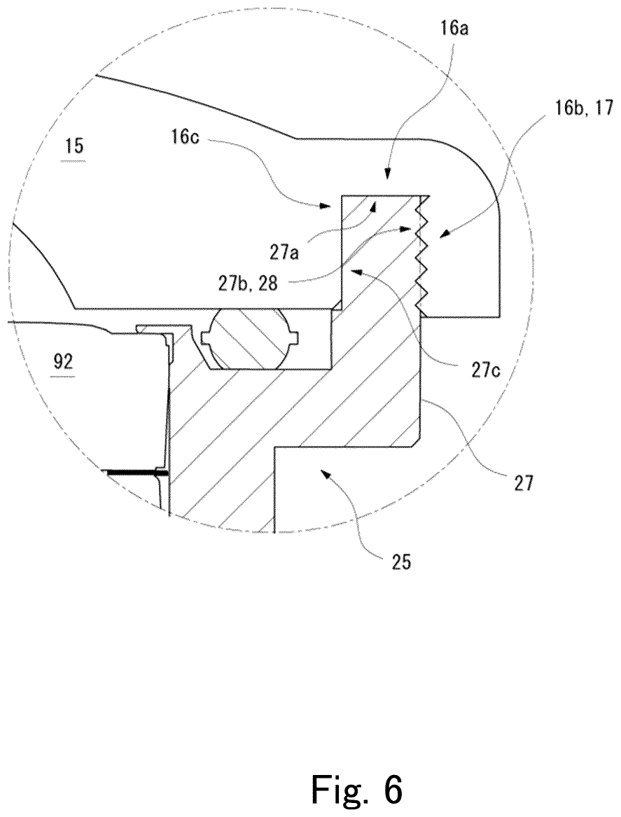

FIG. 5 is a cross-sectional side view showing an internal structure of a lens unit “U2” in accordance with a second embodiment of the present invention. FIG. 6 is an enlarged view showing a portion surrounded by the one-dot chain line in FIG. 5 and is a view showing details of a fixing structure of a first lens 15. Next, a feature of the lens unit “U2” will be described below with reference to FIGS. 5 and 6. In the following descriptions, the same structures as the first embodiment are indicated with the same numeral signs as the former embodiment, and their detailed descriptions are omitted. Further, structures having the same name as the structures in the first embodiment may be considered as those corresponding to the structures in the first embodiment. This is applied to descriptions in a third and subsequent embodiments.

In the lens unit “U1” in the first embodiment, the male screw 111 is provided in the first lens 10 and the female screw 221 is provided in the lens holder 20. However, in the lens unit “U2” in this embodiment, on the contrary, a female screw 17 is provided in a first lens 15 and a male screw 28 is provided in a lens holder 25.

The first lens 15 is formed with a ring-shaped groove part 16 on its lower face. The groove part 16 is structured of a bottom face 16a, an outer wall face 16b which is a wall surface on an outer side in a radial direction, and an inner wall face 16c which is a wall surface on an inner side in the radial direction. The female screw 17 is formed on the outer wall face 16b of the groove part 16, and the male screw 28 is formed on an outer peripheral face 27b of a large diameter part 27 of the lens holder 25. An effect obtained by using a plastic lens to provide the first lens itself with a screw structure is similar to that described in the first embodiment. Further, the lens unit “U2” may be provided with cut-out parts 14 similarly to the lens unit “U1”.

Optical axis direction positioning parts of the lens unit “U2” are structured of the bottom face 16a of the groove part 16 and an upper face 27a of the large diameter part 27 facing the bottom face 16a. Further, radial direction positioning parts of the lens unit “U2” are structured of the inner wall face 16c of the groove part 16 and an inner peripheral face 27c of the large diameter part 27 facing the inner wall face 16c. An effect obtained by providing the optical axis direction positioning parts and/or the radial direction positioning parts separately from the screw structure is similar to that described in the first embodiment.

In this embodiment, the radial direction positioning part is provided by utilizing the inner peripheral face 27c of the large diameter part 27 and thus, the groove part 16 is employed. However, in a case that the radial direction positioning part is not required or, in a case that the radial direction positioning part is provided by a method different from this embodiment, it may be structured that, instead of the groove part 16, for example, the first lens 15 is provided with only a simple tube-shaped part (a structure corresponding to an outer peripheral face of the first lens 15 and an inner wall face 16b of the groove part 16) and a female screw 17 is formed on its inner peripheral face.

### Third Embodiment

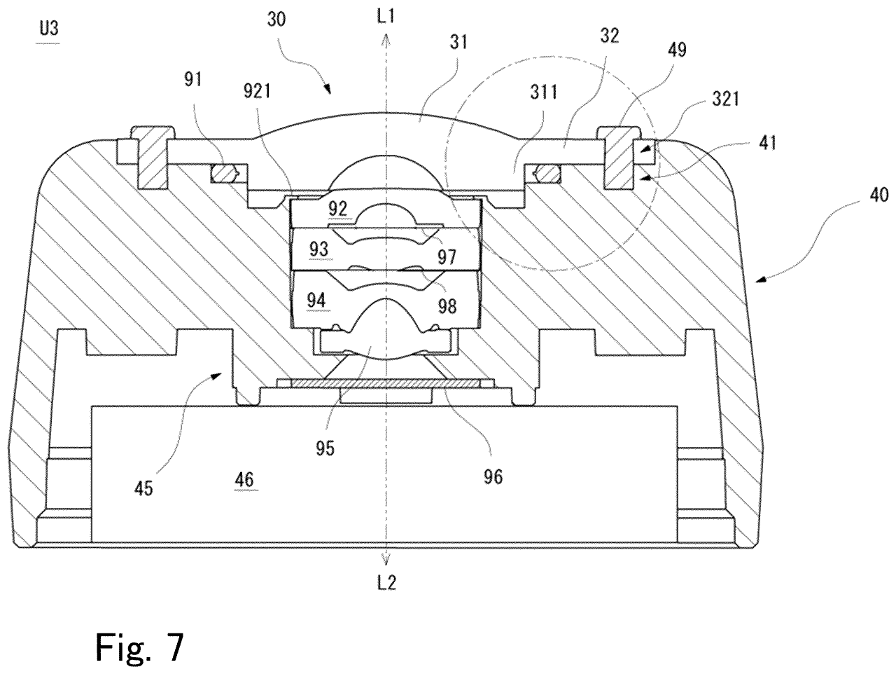

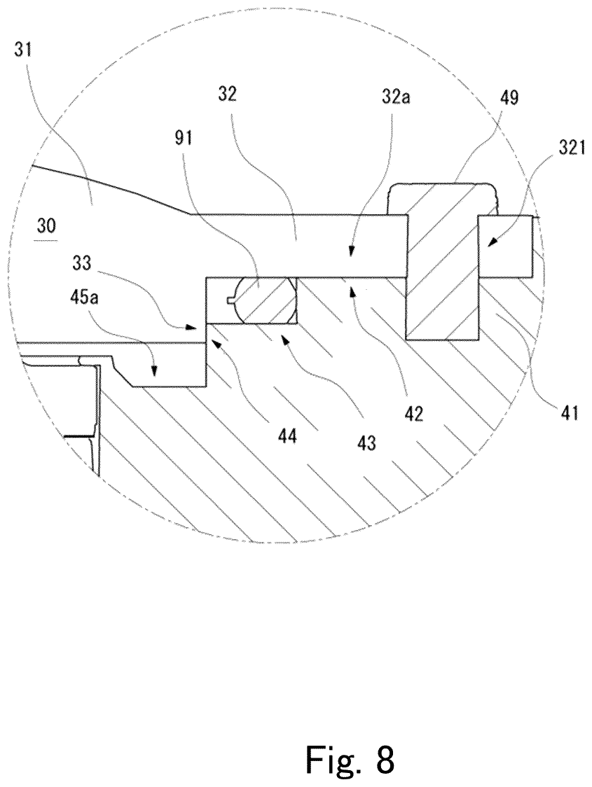

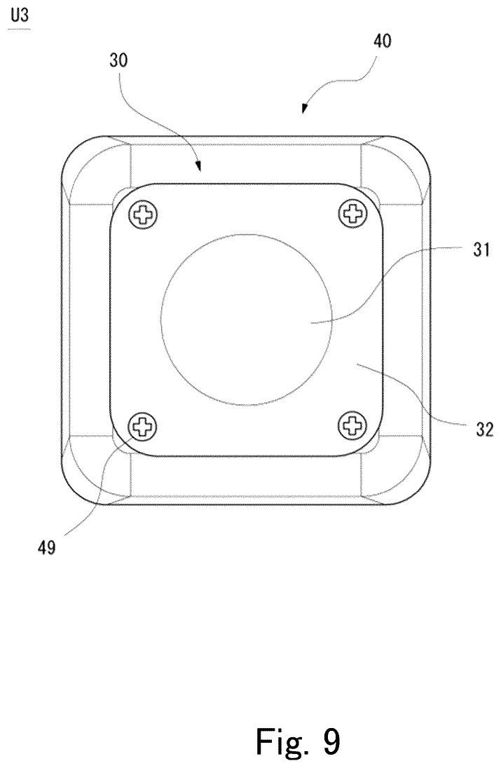

FIG. 7 is a cross-sectional side view showing an internal structure of a camera unit “U3” in accordance with a third embodiment of the present invention. FIG. 8 is an enlarged view showing a portion surrounded by the one-dot chain line in FIG. 7 and is a view showing details of a fixing structure of a first lens 30. FIG. 9 is a plan view showing the camera unit “U3”. Next, a feature of the camera unit “U3” will be described below with reference to FIGS. 7 through 9.

The camera unit “U3” is a small camera unit which is principally used as an in-vehicle camera. The camera unit “U3” has a built-in camera module 46 and has a lens holder part 45 in a tube shape which holds the second lens 92 through the fifth lens 95, the light shielding plate 97, the diaphragm 98 and the optical filter 96. These are accommodated in a camera case 40 which is a case body of the camera unit “U3”.

The first lens 30 of the camera unit “U3” is a plastic lens. The first lens 30 is provided with a lens part 31 which determines its optical performance and a non-lens part 32 which is enlarged from a body part 311 (see FIG. 7) of the lens part 31 to an outer side in a radial direction. As shown in FIG. 9, a planar shape of the non-lens part 32 is a rectangular shape with a round corner and its four corners are fixed with screws 49. The first lens 30 is, as shown in FIG. 8, fixed to an upper face of the camera case 40 by the screw 49 which is inserted into a hole 321 of the non-lens part 32 and fastened to a screw hole 41 of the camera case 40. The hole 321 of the non-lens part 32 is a hole without a screw groove (so-called loose hole or drill hole). Therefore, the first lens 30 may be a glass lens. An O-ring 91 is sandwiched between a lower face 32a of the non-lens part 32 and an upper face of the camera case 40 (O-ring mounting surface 43 described below) and is compressed in an optical axis direction. An effect obtained by fixing the first lens 30 to the camera case 40 by a fixing means using a screw structure is similar to that described in the first embodiment.

As shown in FIG. 8, the upper face of the camera case 40 is formed so that its face position becomes stepwise lower from its outer edge toward a center (lens holder part 45) side. The upper face of the camera case 40 is sequentially formed from its outer edge side toward the center side with a lens mounting surface 42 whose face position is lowered in the same shape as the shape of the first lens 30 (non-lens part 32), an O-ring mounting surface 43 on which an O-ring 91 is disposed, and an upper face 45a of the lens holder part 45.

As shown in FIG. 8, optical axis direction positioning parts of the camera unit “U3” are structured of the lower face 32a of the non-lens part 32 and the lens mounting surface 42 of the camera case 40 facing the lower face 32a. Further, radial direction positioning parts of the camera unit “U3” are structured of a lens side fitting part 33 of the first lens 30 and a case side fitting part 44 of the camera case 40 facing the lens side fitting part 33. The lens side fitting part 33 is an outer peripheral face of the body part 311 (see FIG. 7) of the first lens 30. The case side fitting part 44 is a vertical surface between the O-ring mounting surface 43 and the lens holder upper face 45a. An effect by providing the optical axis direction positioning parts and the radial direction positioning parts separately from the screw structure is similar to the effect described in the first embodiment.

In this embodiment, in order to fix the non-lens part 32 of the first lens 30 with the screws 49, the non-lens part 32 requires a certain area. In other words, a size of the unit may be increased. In the camera unit “U3”, the first lens 30 is directly fixed to the camera case 40 instead of fixing to the lens holder part 45 and thereby, the harmful effect is reduced while obtaining an effect of a fixing means using a screw structure. In this embodiment, when a size of the unit is not increased or, when an increase of its size does not cause a problem, it may be structured that the lens holder part 45 is enlarged and the first lens 30 is fixed to the lens holder part 45 with screws.

### Fourth Embodiment

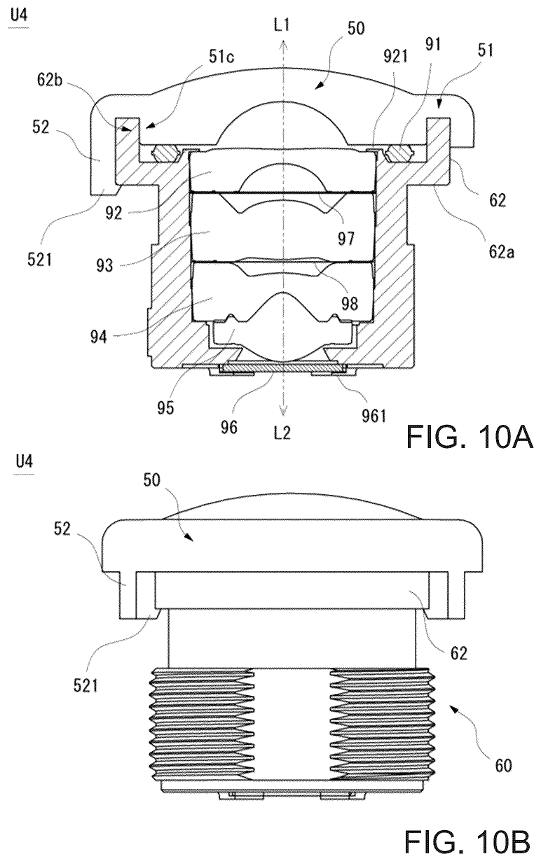

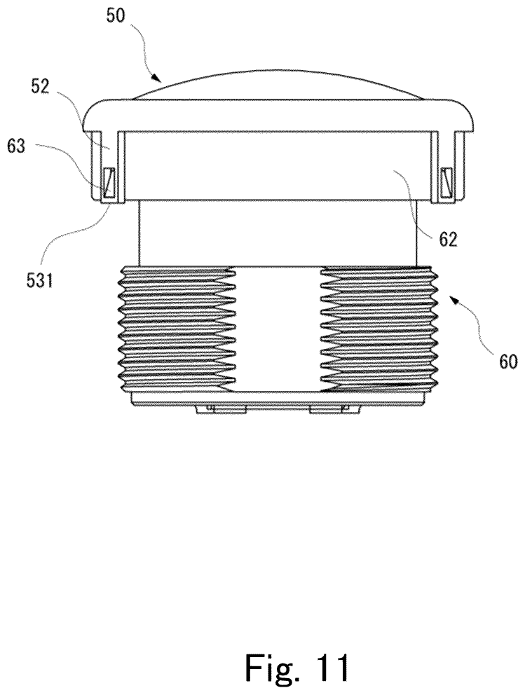

FIG. 10A is a cross-sectional side view showing an internal structure of a lens unit “U4” in accordance with a fourth embodiment of the present invention, and FIG. 10B is its side view. A feature of the lens unit “U4”will be described below with reference to FIGS. 10A and 10B.

In the embodiments described above, the structure is described in which the first lens is fixed to a lens holder or a camera case by a fixing means using a screw structure. However, a fixing means which is capable of detaching a lens after fixation and, in addition, capable of preventing positional deviation of the lens due to a repulsive force of an O-ring is not limited to the means using a screw structure. In the lens unit “U4” described below, instead of a screw structure, a fixing means using an arm capable of being elastically deformed and a hook is adopted for solving the problem.

A first lens 50 of the lens unit U4 is a plastic lens, and its lower face is formed with a ring-shaped groove part 51. Further, a plurality of elastic arms 52 is extended to a lower side from an outer peripheral part of the first lens 50 (from a portion on an outer side in a radial direction with respect to the groove part 51). In this embodiment, three elastic arms 52 are disposed at equal intervals in a circumferential direction. A lower end of each of the elastic arms 52 is provided with a hook 521, and the hook 521 is engaged with a lower face 62a of a large diameter part 62 of a lens holder 60.

In the lens unit “U4”, a plastic lens is used as the first lens 50 and thus, the first lens 50 and the elastic arms 52 are capable of being integrally formed with each other. Further, the first lens 50 is fixed to the lens holder 60 by the hooks 521 of the elastic arms 52 and thus, even after the first lens 50 is fixed, the first lens 50 can be detached without damaging the lens holder 60. In addition, floating of the first lens 50 due to a repulsive force of the O-ring 91 is also prevented. Further, when performance of the first lens 50 is degraded due to a scratch, the first lens 50 can be easily and inexpensively exchanged.

In this embodiment, a position in an optical axis direction of the first lens 50 in the lens unit “U4” is determined by the hook 521 of the elastic arm 52 and the lower face 62a of the large diameter part 62 (because the first lens 50 is always pushed up to an object side due to a repulsive force of the O-ring 91). Further, a position in the radial direction of the first lens 50 is determined by an inner wall face 51c which is an inner side face in the radial direction of the wall surfaces of the groove part 51 and an inner peripheral face 62b of the large diameter part 62 facing the inner wall face 51c.

### (Modified Embodiment)

FIG. 11 is a side view showing a modified embodiment of the lens unit “U4”. As shown in FIG. 11, the elastic arm 52 and the hook 521 may be structured so that a hook 63 is provided in the lens holder 60 and the elastic arm 52 is provided with a hole 531 which is fitted and engaged with the hook 63.

### Embodiments

The embodiments of the present invention may be structured as follows.
(1) A lens unit including a first lens which is a lens, a lens holder in a tube shape which holds the first lens, and an O-ring which is a seal member, where the first lens is fixed to the lens holder by a fixing means using a screw structure, and the O-ring is sandwiched between the first lens and the lens holder in an optical axis direction.
(2) The lens unit described in the above-mentioned structure (1), where the first lens is a plastic lens, and the fixing means is structured of a male screw which is formed on an outer peripheral face of the first lens and a female screw which is formed on an inner peripheral face of the lens holder.
(3) The lens unit described in the above-mentioned structure (2), where the first lens and the lens holder include, separately from the fixing means, optical axis direction positioning parts which are contacted with each other in the optical axis direction to determine a position in the optical axis direction of the first lens with respect to the lens holder, when a direction perpendicular to the optical axis direction is referred to as a radial direction, the first lens is provided with a flange part which is protruded to an outer side in the radial direction with respect to a position of the male screw on an object side with respect to the male screw, and the optical axis direction positioning parts are structured of an image side face of the flange part and a face of the lens holder facing the image side face.
(4) The lens unit described in the above-mentioned structure (2) or (3), where when a direction perpendicular to the optical axis direction is referred to as a radial direction, the first lens and the lens holder include, separately from the fixing means, radial direction positioning parts which are contacted with each other in the radial direction to determine a position in the radial direction of the first lens with respect to the lens holder, the first lens is provided with a fitting part in a cylindrical tubular shape or a columnar shape on an image side with respect to the male screw, and the radial direction positioning parts are structured of an outer peripheral face of the fitting part and a face of the lens holder facing the outer peripheral face.
(5) The lens unit described in the above-mentioned structure (2) or (3), where when a direction perpendicular to the optical axis direction is referred to as a radial direction, the first lens and the lens holder include, separately from the fixing means, radial direction positioning parts which are contacted with each other in the radial direction to determine a position in the radial direction of the first lens with respect to the lens holder, the first lens is provided with a fitting part in a cylindrical tubular shape or a columnar shape on an object side with respect to the male screw, and the radial direction positioning parts are structured of an outer peripheral face of the fitting part and a face of the lens holder facing the outer peripheral face.
(6) The lens unit described in the above-mentioned structure (4) or (5), where the outer peripheral face of the fitting part is disposed on an outer side in the radial direction with respect to a position of the O-ring.
(7) The lens unit described in the above-mentioned structure (1), where the first lens is a plastic lens having a tube-shaped part, and the fixing means is structured of a male screw which is formed on an outer peripheral face of the lens holder and a female screw which is formed on an inner peripheral face of the tube-shaped part.
(8) The lens unit described in the above-mentioned structure (7), where the first lens and the lens holder include, separately from the fixing means, optical axis direction positioning parts which are contacted with each other in the optical axis direction to determine a position in the optical axis direction of the first lens with respect to the lens holder, an image side face of the first lens is formed with a ring-shaped groove part, when a direction perpendicular to the optical axis direction is referred to as a radial direction, the female screw is formed on a wall surface on an outer side in the radial direction of wall surfaces of the groove part, and the optical axis direction positioning parts are structured of a bottom face of the groove part and a face of the lens holder facing the bottom face.
(9) The lens unit described in the above-mentioned structure (8), where the first lens and the lens holder include, separately from the fixing means, radial direction positioning parts which are contacted with each other in the radial direction to determine a position in the radial direction of the first lens with respect to the lens holder, and the radial direction positioning parts are structured of a wall surface on an inner side in the radial direction of the wall surfaces of the groove part and a face of the lens holder facing the wall surface.
(10) The lens unit described in one of the above-mentioned structures (1) through (9), where an outer face of the first lens is provided with a protrusion or a recess such as a recessed part, protruded part, notch, knurling, serration, spline or the like capable of engaging with a jig, a tool or a finger in a circumferential direction in a portion which does not affect optical performance.
(11) The lens unit described in the above-mentioned structure (1), where when a direction perpendicular to the optical axis direction is referred to as a radial direction, the first lens is provided with a lens part which determines its optical performance and a non-lens part which is enlarged from the lens part to an outer side in the radial direction, the non-lens part is formed with a plurality of holes, and the first lens is fixed to the lens holder by passing a screw through the hole of the non-lens part.
(12) The lens unit described in the above-mentioned structure (11), where the first lens and the lens holder include, separately from the fixing means, optical axis direction positioning parts which are contacted with each other in the optical axis direction to determine a position in the optical axis direction of the first lens with respect to the lens holder, and the optical axis direction positioning parts are structured of an image side face of the non-lens part and a face of the lens holder facing the image side face.
(13) The lens unit described in the above-mentioned structure (11) or (12), where the first lens and the lens holder include, separately from the fixing means, radial direction positioning parts which are contacted with each other in the radial direction to determine a position in the radial direction of the first lens with respect to the lens holder, the first lens is provided with a fitting part in a cylindrical tubular shape or a columnar shape on an inner side in the radial direction with respect to the O-ring, and the radial direction positioning parts are structured of an outer peripheral face of the fitting part and a face of the lens holder facing the outer peripheral face.
(14) The lens unit described in one of the above-mentioned structures (1) through (13), where the first lens and the lens holder include, separately from the fixing means, optical axis direction positioning parts which are contacted with each other in the optical axis direction to determine a position in the optical axis direction of the first lens with respect to the lens holder.
(15) The lens unit described in one of the above-mentioned structures (1) through (14), where when a direction perpendicular to the optical axis direction is referred to as a radial direction, the first lens and the lens holder include, separately from the fixing means, radial direction positioning parts which are contacted with each other in the radial direction to determine a position in the radial direction of the first lens with respect to the lens holder.
(16) The lens unit described in one of the above-mentioned structures (1) through (15), where the first lens and the lens holder are joined to each other with an adhesive.
(17) The lens unit described in the above-mentioned structure (16), where the adhesive is a dismantlable adhesive which is capable of releasing adhesion by performing specific processing on a joined part after bonding.
(18) The lens unit described in one of the above-mentioned structures (1) through (17), further including a plurality of lenses which are arranged along the optical axis direction, where the first lens is a lens disposed on the most object side among the plurality of the lenses, and a lens which is disposed on an image side with respect to the first lens is caulked and fixed to the lens holder.
(19) A camera unit including a plurality of lenses arranged along an optical axis direction, a lens holder in a tube shape, an O-ring which is a seal member, a camera module, and a camera case accommodating the camera module, where when a lens on the most object side among the plurality of the lenses is referred to as a first lens, the lens holder holds a lens disposed on an image side with respect to the first lens, when a direction perpendicular to the optical axis direction is referred to as a radial direction, the first lens is provided with a lens part which determines its optical performance and a non-lens part which is enlarged from the lens part to an outer side in the radial direction, the non-lens part is formed with a plurality of holes, the first lens is fixed to a face on an object side of the camera case by passing a screw through the hole of the non-lens part, and the O-ring is sandwiched between the first lens and the camera case or the lens holder in the optical axis direction.

Although the present invention has been shown and described with reference to specific embodiments, the present invention is not limited to the above-mentioned embodiments and various changes and modifications will be apparent to those skilled in the art from the teachings herein.

1. A lens unit comprising:
a first lens which is a lens;
a lens holder in a tube shape which holds the first lens; and
an O-ring which is a seal member;
wherein the first lens is fixed to the lens holder by a fixing means using a screw structure; and
the O-ring is sandwiched between the first lens and the lens holder in an optical axis direction.

2. The lens unit according to claim 1, wherein
the first lens is a plastic lens, and
the fixing means is structured of a male screw which is formed on an outer peripheral face of the first lens and a female screw which is formed on an inner peripheral face of the lens holder.

3. The lens unit according to claim 2, wherein
the first lens and the lens holder comprise, separately from the fixing means, optical axis direction positioning parts which are contacted with each other in the optical axis direction to determine a position in the optical axis direction of the first lens with respect to the lens holder,
when a direction perpendicular to the optical axis direction is referred to as a radial direction, the first lens comprises a flange part which is protruded to an outer side in the radial direction with respect to a position of the male screw on an object side with respect to the male screw, and
the optical axis direction positioning parts are structured of an image side face of the flange part and a face of the lens holder facing the image side face.

4. The lens unit according to claim 2, wherein
when a direction perpendicular to the optical axis direction is referred to as a radial direction, the first lens and the lens holder comprise, separately from the fixing means, radial direction positioning parts which are contacted with each other in the radial direction to determine a position in the radial direction of the first lens with respect to the lens holder,
the first lens comprises a fitting part in a cylindrical tubular shape or a columnar shape on an image side with respect to the male screw, and
the radial direction positioning parts are structured of an outer peripheral face of the fitting part and a face of the lens holder facing the outer peripheral face.

5. The lens unit according to claim 2, wherein
when a direction perpendicular to the optical axis direction is referred to as a radial direction, the first lens and the lens holder comprise, separately from the fixing means, radial direction positioning parts which are contacted with each other in the radial direction to determine a position in the radial direction of the first lens with respect to the lens holder,
the first lens comprises a fitting part in a cylindrical tubular shape or a columnar shape on an object side with respect to the male screw, and
the radial direction positioning parts are structured of an outer peripheral face of the fitting part and a face of the lens holder facing the outer peripheral face.

6. The lens unit according to claim wherein the outer peripheral face of the fitting part is disposed on an outer side in the radial direction with respect to a position of the O-ring.

7. The lens unit according to claim 1, wherein
the first lens is a plastic lens having a tube-shaped part, and
the fixing means is structured of a male screw which is formed on an outer peripheral face of the lens holder and a female screw which is formed on an inner peripheral face of the tube-shaped part.

8. The lens unit according to claim 7, wherein
the first lens and the lens holder comprise, separately from the fixing means, optical axis direction positioning parts which are contacted with each other in the optical axis direction to determine a position in the optical axis direction of the first lens with respect to the lens holder,
an image side face of the first lens is formed with a ring-shaped groove part,
when a direction perpendicular to the optical axis direction is referred to as a radial direction, the female screw is formed on a wall surface on an outer side in the radial direction of wall surfaces of the groove part, and
the optical axis direction positioning parts are structured of a bottom face of the groove part and a face of the lens holder facing the bottom face.

9. The lens unit according to claim 8, wherein
the first lens and the lens holder comprise, separately from the fixing means, radial direction positioning parts which are contacted with each other in the radial direction to determine a position in the radial direction of the first lens with respect to the lens holder, and
the radial direction positioning parts are structured of a wall surface on an inner side in the radial direction of the wall surfaces of the groove part and a face of the lens holder facing the wall surface.

10. The lens unit according to claim 2, wherein an outer face of the first lens comprises a protrusion or a recess such as a recessed part, protruded part, notch, knurling, serration, spline or the like capable of engaging with a jig, a tool or a finger in a circumferential direction in a portion which does not affect optical performance.

11. The lens unit according to claim 1, wherein
when a direction perpendicular to the optical axis direction is referred to as a radial direction, the first lens comprises a lens part which determines its optical performance and a non-lens part which is enlarged from the lens part to an outer side in the radial direction,
the non-lens part is formed with a plurality of holes, and
the first lens is fixed to the lens holder by passing a screw through the hole of the non-lens part.

12. The lens unit according to claim 11, wherein
the first lens and the lens holder comprise, separately from the fixing means, optical axis direction positioning parts which are contacted with each other in the optical axis direction to determine a position in the optical axis direction of the first lens with respect to the lens holder, and
the optical axis direction positioning parts are structured of an image side face of the non-lens part and a face of the lens holder facing the image side face.

13. The lens unit according to claim 11, wherein
the first lens and the lens holder comprise, separately from the fixing means, radial direction positioning parts which are contacted with each other in the radial direction to determine a position in the radial direction of the first lens with respect to the lens holder,
the first lens is provided with a fitting part in a cylindrical tubular shape or a columnar shape on an inner side in the radial direction with respect to the O-ring, and
the radial direction positioning parts are structured of an outer peripheral face of the fitting part and a face of the lens holder facing the outer peripheral face.

14. The lens unit according to claim 1, wherein the first lens and the lens holder comprise, separately from the fixing means, optical axis direction positioning parts which are contacted with each other in the optical axis direction to determine a position in the optical axis direction of the first lens with respect to the lens holder.

15. The lens unit according to claim 1, wherein when a direction perpendicular to the optical axis direction is referred to as a radial direction, the first lens and the lens holder comprise, separately from the fixing means, radial direction positioning parts which are contacted with each other in the radial direction to determine a position in the radial direction of the first lens with respect to the lens holder.

16. The lens unit according to claim 1, wherein the first lens and the lens holder are joined to each other with an adhesive.

17. The lens unit according to claim 16, wherein the adhesive is a dismantlable adhesive which is capable of releasing adhesion by performing specific processing on a joined part after bonding.

18. The lens unit according to claim 1, further including a plurality of lenses which are arranged along the optical axis direction,
wherein the first lens is a lens disposed on a most object side among the plurality of the lenses, and
a lens which is disposed on an image side with respect to the first lens is caulked and fixed to the lens holder.

19. A camera unit comprising:
a plurality of lenses arranged along an optical axis direction;
a lens holder in a tube shape;
an O-ring which is a seal member;
a camera module; and
a camera case accommodating the camera module;
wherein when a lens on a most object side among the plurality of the lenses is referred to as a first lens, the lens holder holds a lens disposed on an image side with respect to the first lens;
when a direction perpendicular to the optical axis direction is referred to as a radial direction, the first lens comprises a lens part which determines its optical performance and a non-lens part which is enlarged from the lens part to an outer side in the radial direction;
the non-lens part is formed with a plurality of holes;
the first lens is fixed to a face on an object side of the camera case by passing a screw through the hole of the non-lens part, and
the O-ring is sandwiched between the first lens and the camera case or the lens holder in the optical axis direction.
